(19) United States
(12) Patent Application Publication
(10) Pub. No.: US 2007/0019434 A1
(43) Pub. Date: Jan. 25, 2007

(54) Turning film having variable pitch

(75) Inventor: Junwon Lee, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/188,153

(22) Filed: Jul. 22, 2005

(51) Int. Cl. F21V 7/04

(52) U.S. Cl. 362/606; 362/607; 362/330

(57) ABSTRACT

A light-redirecting article has a width and a length and has a light-redirecting surface with a plurality of light-redirecting structures elongated along the length of the light-redirecting article and arranged side-by-side. Each light-redirecting structure has a first side surface oriented away from a normal to the light-redirecting article at a first angle and a second side surface oriented away from a normal to the light-redirecting article at a second angle. The first and second side surfaces meet at an apex. The cross-sectional shape of each light-redirecting structure has at least one convex surface. For at least two adjacent light-redirecting structures, over the length of the at least two adjacent light-redirecting structures, the widthwise pitch between apexes of the adjacent light-redirecting structures varies by more than +/−3%.

### FIELD OF THE INVENTION

This invention generally relates to display illumination articles for enhancing luminance from a two-dimensional surface and more particularly relates to a two-dimensional turning film employing light re-directing structures having variable pitch to redirect light from a light guiding plate.

### BACKGROUND OF THE INVENTION

Liquid crystal displays (LCDs) continue to improve in cost and performance, becoming a preferred display type for many computer, instrumentation, and entertainment applications. The transmissive LCD used in conventional laptop computer displays is a type of backlit display, having a light providing surface positioned behind the LCD for directing light outwards, towards the LCD. The challenge of providing a suitable backlight apparatus having brightness that is sufficiently uniform while remaining compact and low cost has been addressed following one of two basic approaches. In the first approach, a light-providing surface is used to provide a highly scattered, essentially Lambertian light distribution, having an essentially constant luminance over a broad range of angles. Following this first approach, with the goal of increasing on-axis and near-axis luminance, a number of brightness enhancement films have been proposed for redirecting a portion of this light having Lambertian distribution in order to provide a more collimated illumination. Among proposed solutions for brightness enhancement films are those described in U.S. Pat. No. 5,592,332 (Nishio et al.); U.S. Pat. No. 6,111,696 (Allen et al); U.S. Pat. No. 6,280,063 (Fong et al.); U.S. Pat. No. 5,629,784 (Abileah et al.), and U.S. Patent Application Publication 2003/0214728 for example. Solutions such as the brightness enhancement film (BEF) described in patents cited above provide some measure of increased brightness over wide viewing angles. However, overall contrast of a typical liquid crystal display (LCD), even with a BEF, remains relatively poor.

A second approach to providing backlight illumination employs a light guiding plate (LGP) that accepts incident light from a lamp or other light source disposed at the side and guides this light internally using Total Internal Reflection (TIR) so that light is emitted from the lightguide plate over a narrow range of angles. The output light from the LGP is typically at a fairly steep angle with respect to the normal to the LGP, such as 80 degrees or more. With this second approach, a turning film, one type of light redirecting article, is then used to redirect the emitted light output from the LGP toward normal. Directional turning films, broadly termed light-redirecting articles or light-redirecting films, such as that provided with the HSOT (Highly Scattering Optical Transmission) light guide panel available from Clarex, Inc., Baldwin, N.Y., provide an improved solution for providing a uniform backlight of this type, without the need for diffusion films or for dot printing in manufacture. HSOT light guide panels and other types of directional turning films use arrays of prism structures, in various combinations, to redirect light from a light guiding plate toward normal, relative to the two-dimensional surface. As one example, U.S. Pat. No. 6,746,130 (Ohkawa) describes a light control sheet that acts as a turning film for LGP illumination. The projection rows of the turning film run in parallel with each other and have one face that has a variation in the inclination angle of the face. U.S. Pat. No. 6,874,902 (Yamashita et al) describes a light deflecting device having plural elongated prisms arranged parallel to each other wherein a prism face of each elongated prism at the far side from the primary light source is designed to have a convex surface shape.

Referring to FIG. 1, the overall function and operation of a light guiding plate 10 in a display apparatus 30 is shown. Light from a light source 12 is incident at an input surface 18 and passes into light guiding plate 10, which may be wedge-shaped as shown. The light propagates within light guiding plate 10 until Total Internal Reflection (TIR) conditions are frustrated and then, possibly reflected from a reflective surface 42, exits light guiding plate at an output surface 16. This light then goes to a turning film 22 and is directed to illuminate a light-modulating device 20 such as an LCD or other two-dimensional backlit component.

While turning films 22 are useful for increasing display brightness, some performance drawbacks remain. Prismatic light-redirecting structures of conventional turning films are spaced along the sheet of film with a given periodicity. At the same time, pixel-forming structures of light-modulating device 20 itself also have a spatially periodic arrangement. Undesirable Moiré patterns result from the superposition of these two periodic patterns, as is well known to those skilled in the imaging arts. To minimize Moiré, or eliminate it altogether, would require suppressing the periodicity of either the light-redirecting film or of the pixels of the light-modulating layer.

U.S. Pat. No. 6,707,611 entitled “Optical Film with Variable Angle Prisms” to Gardiner et al. discloses optimized geometric arrangements for the prism surface on the incident light surface of a turning film, with various configurations of angled surfaces, spacings, and curvatures in order to reduce Moiré. However, the approaches disclosed in the '611 Gardiner et al. patent can require complex tooling and it may prove difficult to control illumination uniformity with a turning film fabricated in this manner. Korean Patent 20-0364045 describes a brightness enhancement film that has prism rows consisting of multiple curved prism units consisting of at least one meandering surface. However, this feature may degrade optical brightness due to the variation in the microstructure.

There is still a need for a light redirecting film design that minimizes or eliminates Moiré but that still maintains good optical brightness.

### SUMMARY OF THE INVENTION

This invention provides a light-redirecting article having a width and a length, comprising:
a light-redirecting surface comprising a plurality of light-redirecting structures elongated along the length of the light-redirecting article and arranged side-by-side,
wherein each light-redirecting structure comprises:
   (i) a first side surface oriented away from a normal to the light-redirecting article at a first angle;
   (ii) a second side surface oriented away from a normal to the light-redirecting article at a second angle,
wherein the cross-sectional shape of each light-redirecting structure has at least one convex surface;
wherein the first and second side surfaces meet at an apex; and
wherein, for at least two adjacent light redirecting structures, over the length of the adjacent light-redirecting structures the widthwise pitch between apexes of the adjacent light-redirecting structures varies by more than +/−3%.

This invention further provides a method of manufacture of a light-redirecting article comprising
a) rotating a cylinder;
b) scribing the rotating cylinder with a tool to form adjacent scribe marks having a pitch that, over one full rotation of the cylinder, varies by more than +/−3%;
c) forming the light-redirecting article using the scribed cylinder in an injection roll molding process.

This invention also provides a display apparatus comprising
a) a light source;
b) a light guiding plate for directing light from the light source outward from an output surface, over a range of angles;
c) a light-redirecting article for accepting the light from the light guiding plate, the light redirecting article having a width and a length, comprising:
   a light-redirecting surface comprising a plurality of light-redirecting structures elongated along the length of the light-redirecting article and arranged side-by-side,
wherein each light-redirecting structure comprises:
   (i) a first side surface oriented away from a normal to the light-redirecting article at a first angle;
   (ii) a second side surface oriented away from a normal to the light-redirecting article at a second angle,
wherein the cross-sectional shape of each light-redirecting structure has at least one convex surface;
wherein the first and second side surfaces meet at an apex; and
wherein, for at least two adjacent light redirecting structures, over the length of the adjacent light-redirecting structures the widthwise pitch between apexes of the adjacent light-redirecting structures varies by more than +/−3%.
the light-redirecting article providing illumination thereby; and,
d) a light gating device for modulating the incident illumination from the light-redirecting article.

This invention provides a light redirecting element that provides incident illumination for a display with a reduced Moire appearance and that provides good optical brightness. The varying pitch of the light redirecting structures suppresses Moire, however, this feature may degrade optical brightness due to the variation in the microstructure. In order to compensate, one surface of the light redirecting structure is designed to have a curvature such that it redirects light to a near normal viewing direction more efficiently and prevents optical brightness reduction.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a side view showing the relationship of the turning film to the light guiding plate and to light-modulating components of an electronic display apparatus;

FIG. 2 is a perspective view of the light-redirecting surface of a turning film according to the present invention;

FIG. 3 is a perspective view of the light-redirecting surface of a turning film according to the present invention from the perspective of the light guiding plate;

FIG. 4 is a plan view showing the randomized paths followed by light-redirecting structures on a turning film of the present invention;

FIG. 5A is an illustrative figure showing a non-inventive embodiment;

FIG. 5B is a view showing pitch and staggering for a light-redirecting structures according to the present invention;

FIG. 6 is a graph showing Fourier transform characteristics that show the potential reduced Moiré effects obtainable using the turning film design of the present invention;

FIG. 7 is a perspective view showing how surface structures on turning film of the present invention are formed;

FIGS. 8A and 8B compare relative luminance levels using different embodiments of the present invention;

FIG. 9 is an enlarged side view showing, in cross section, the structure shape for light-redirecting structures in one embodiment

FIG. 10 is a side view showing a turning film provided according to the present invention;

FIG. 11 is a side view in cross-section of a tool used for forming a mold for a light redirecting article according to the present invention; and,

FIG. 12 is a side view in cross-section of light redirecting structures showing dimensional features.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The present invention provides a light-redirecting article, such as a turning film for example, having a randomized pattern of light-redirecting structures for minimizing or eliminating Moiré and related frequency effects. In general the light redirecting article has a light-redirecting surface comprising a plurality of light-redirecting structures elongated along the length of the light-redirecting article and arranged side-by-over the length of the at least two adjacent light-redirecting structures. The widthwise pitch between apexes of the adjacent light-redirecting structures varies by more than +/−3%. Preferably the widthwise pitch between the apexes of the adjacent light-redirecting structures increases and decreases in a random pattern over the length of the light-redirecting article. More preferably the pitch between the apexes of the adjacent light-redirecting structures increases and decreases by more than +/−3% in a random pattern over the length of the light-redirecting article. In one embodiment the apexes of at least two adjacent light-redirecting structures trace a substantially sinusoidal path along the length of the light-redirecting. The light redirecting structures are not parallel, since not arranged along straight lines as discussed in more detail below, however, the light redirecting structures do not intersect each other.

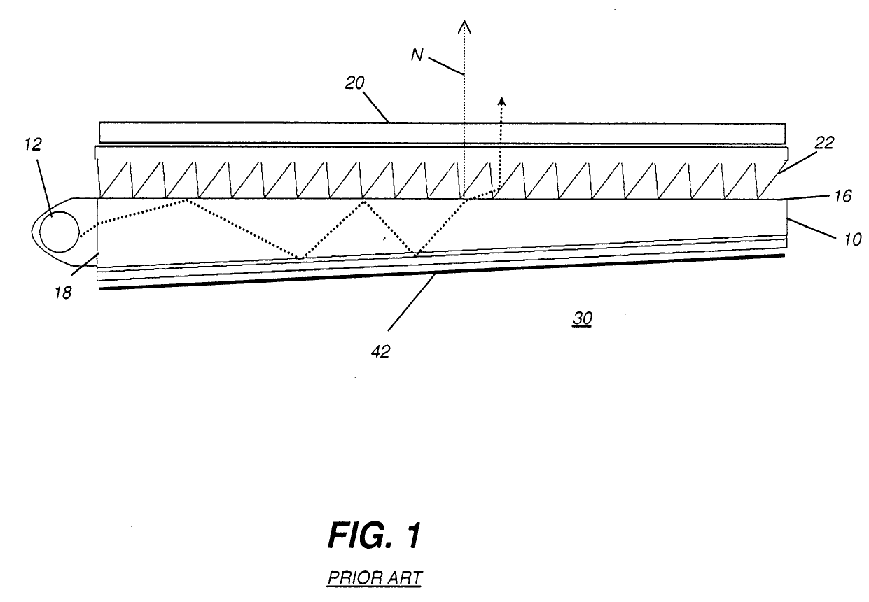

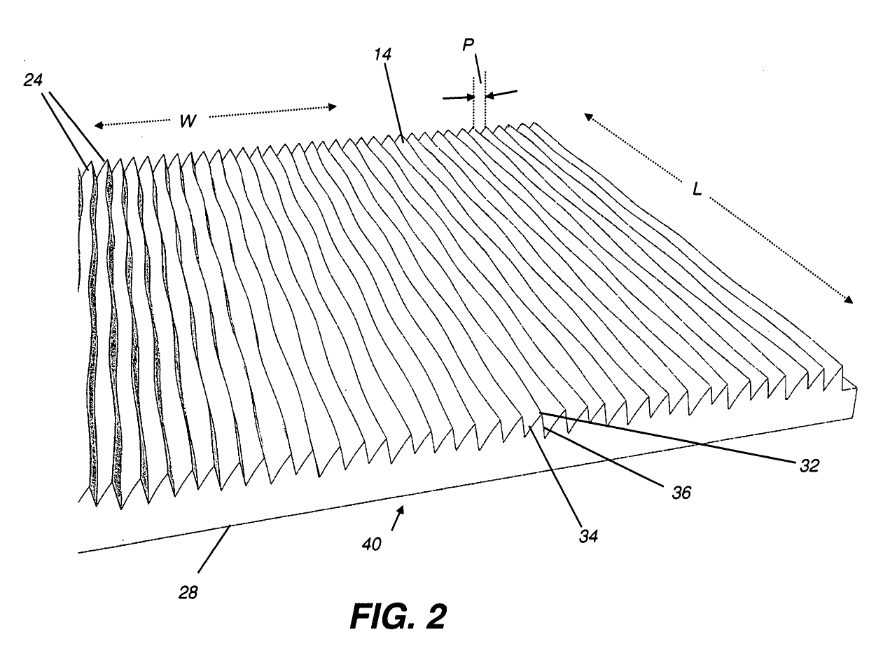

Referring to FIG. 2 which shows one embodiment of the invention, there is shown a light-redirecting surface 14 of a light-redirecting article 40. Light redirecting surface 14 faces light guiding plate 10 and is usually oriented downwards when shown in conventional representation, such as in the arrangement of FIG. 1. On light-redirecting surface 14, light-redirecting structures 24 are arranged side-by-side, with each light-redirecting structure 24 elongated in a length direction L. Each light-redirecting structure 24 has at least two surfaces 34, 36 that meet at an apex 32 that defines its highest point, at the maximum distance from an output face 28. The pitch P between apexes 32 of adjacent light-redirecting structures 24 is measured in the width direction W, orthogonal to length direction L.

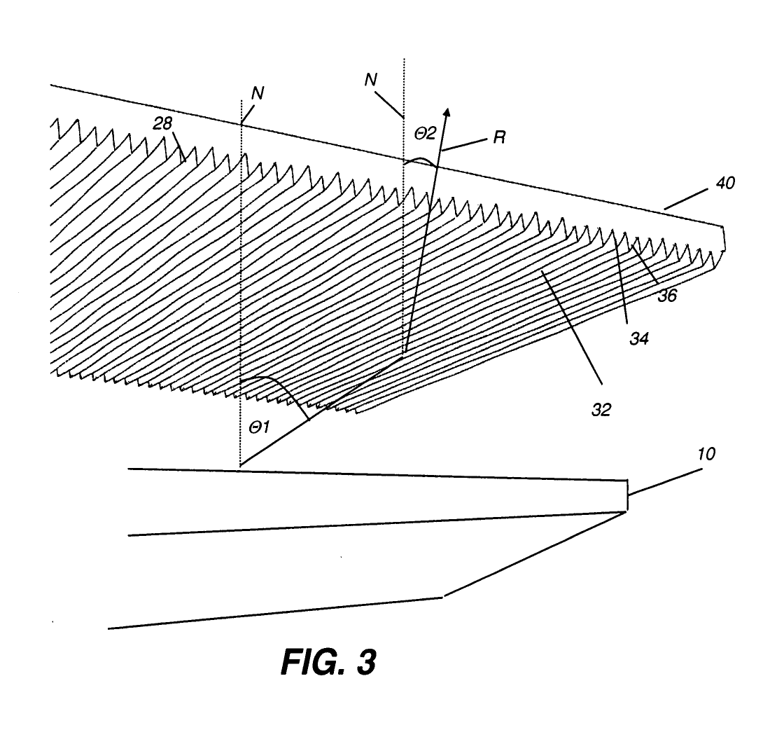

FIG. 3 shows the behavior of light-redirecting article 40 to an incident ray of light R from light guiding plate 10. Light incident at a first angle θ1 is redirected by light-redirecting article 40 to a second angle θ2 that is closer to normal N. This redirected light at angle θ2is then emitted from output face 28.

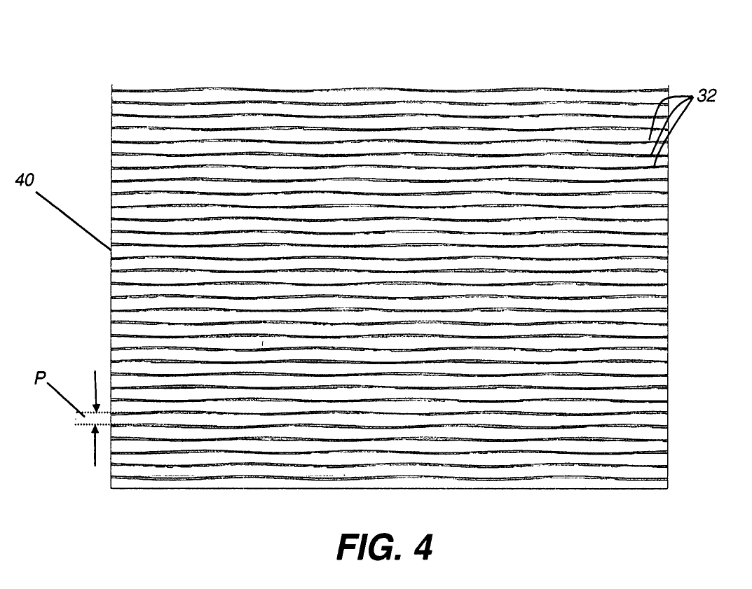

As is shown in FIGS. 2, 3, and 4, light-redirecting structures 24, while generally arranged in parallel along light-redirecting surface 14, are not elongated in straight lines. Instead, a measure of randomness has been introduced, so that each light-redirecting structure 24 follows a path that is somewhat serpentine along length direction L. With this arrangement, the pitch P between apexes 32 of adjacent light-redirecting structures 24 varies from one point to the next along direction L. Where the average pitch P is in the range of 50 microns, the variation in pitch P from this average value is at least about 3 microns or roughly about 6% (that is, +/−3%) of average pitch P. A variation value in this range or higher works well for improving brightness while minimizing Moiré, without introducing other unwanted optical effects. Slightly more variation could be introduced, preferably not exceeding about 12% to 20% variation over length L. This upper limit for pitch P variation may be more constrained by fabrication methods than by optical considerations. Variation in pitch P effectively causes surfaces 34 and 36 of light-redirecting structures 24 to be correspondingly undulating rather than straight.

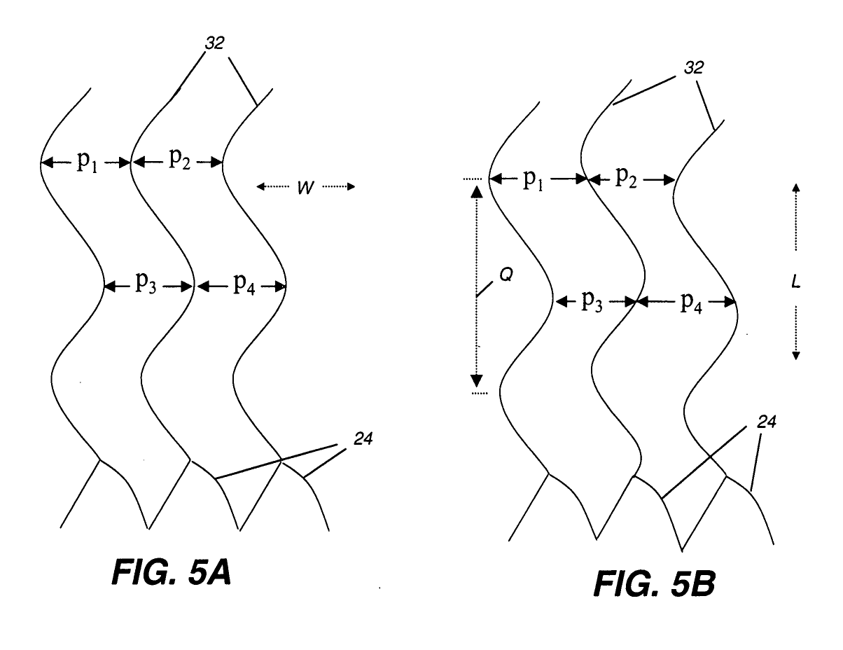

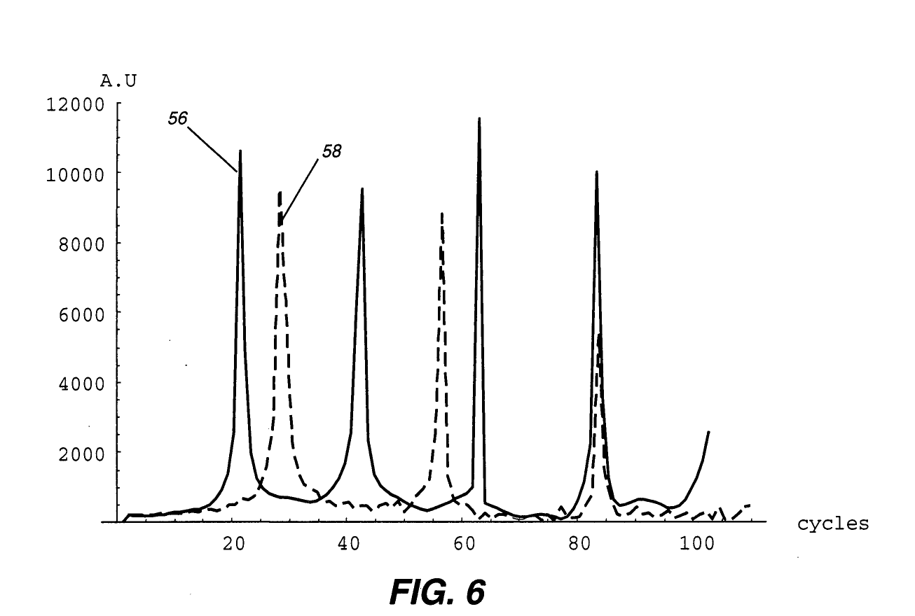

It must be observed that variation in pitch P between adjacent light-redirecting structures 24 requires not only that the path of each elongated light-redirecting structure 24 vary from a straight line but also that paths for adjacent light-redirecting structure 24 be non-parallel. Referring to FIG. 5A, there is shown an arrangement of light-redirecting structures 24 following non-linear paths that are equally spaced apart from each other at each point and substantially sinusoidal. In this arrangement, pitch values P1, P2, P3, and P4 are equal, that is:
P1=P1=P3=P4

While this arrangement provides some measure of randomness, the pitch P, taken in the width W direction, does not vary between adjacent light-redirecting structures 24. In contrast, FIG. 5B shows the arrangement of the present invention, with adjacent rows having the same period Q but different in phase. With this arrangement, pitch values P1, P2, P3, and P4 have the following relationships:
P1 not equal to P2
P2 not equal to P3
   (While pitch P1 may equal pitch P4 at various points, these values are measured along different points of length L.) In this way, an embodiment of the present invention using a sinusoidal arrangement of light-redirecting structures 24 provides an increased amount of randomness, reducing the likelihood of Moiré. To provide this randomness, the sinusoidal patterns for adjacent light-redirecting structures 24 are staggered, randomizing the periodic relationship thereby. The amplitude of the sine wave that is traced can also be varied between adjacent light-redirecting structures 24.

It has been determined that there is some improvement to Moiré patterning when pitch P between adjacent light-redirecting structures 24 varies by at least a threshold value of about 6% (that is, +/−3%) over the length of light-redirecting surface 14. This pitch variation is computed as follows:

$$( \frac{{P}_{i} - {P}_{average}}{{P}_{average}} ) \times 100 \%$$

where P_{average} is the average pitch and Pᵢ is the pitch from any point on one light-redirecting structure 24 to the next.

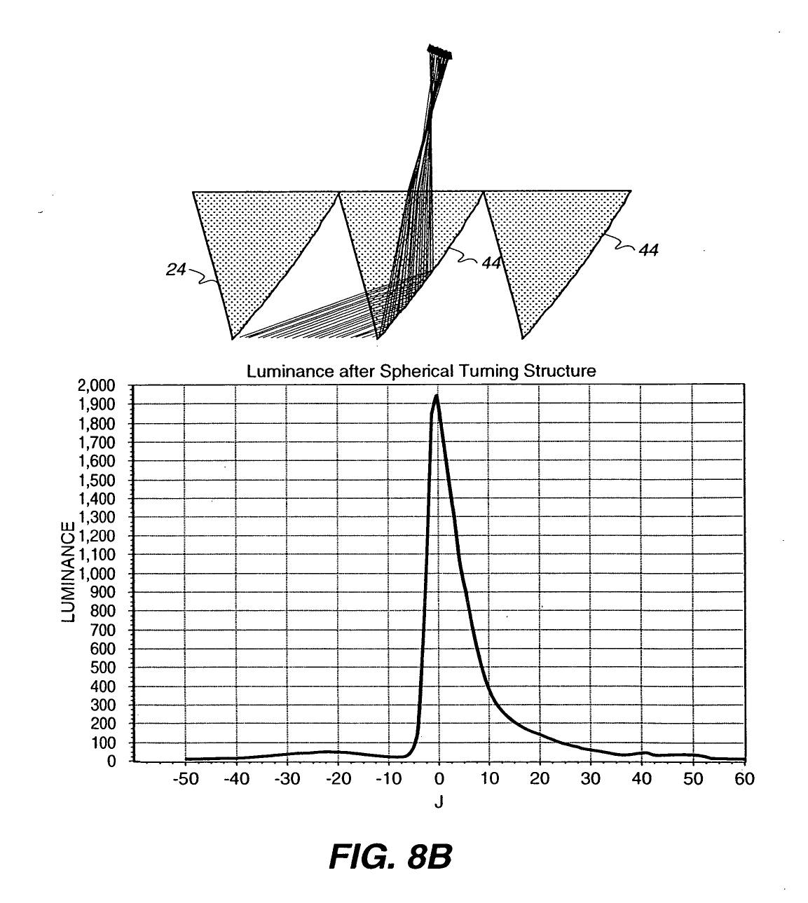

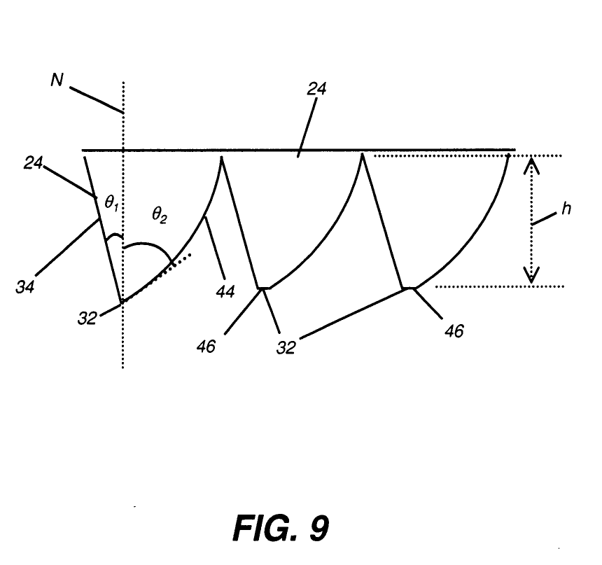

FIG. 9 shows, in cross section, the general structural arrangement of one example of light-redirecting structure 24 according to the present invention. Light-redirecting article 40 of the present invention has light-redirecting structures 24, wherein each light-redirecting structure 24 has side surface 34 and a convex curved surface 44 each angled or curved with respect to normal N. In FIG. 9, a first side surface 34 is oriented from normal N at an angle θ1 and a second side surface 44 is oriented from normal N at an angle θ2. In one embodiment, second side surface 44 is a spherical surface (that is, having a shape defined as a segment of a sphere as is commonly understood in the optical arts) with a radius of curvature between 100 microns and 1 mm. Surface curvature can be advantageous for providing improved light angles, providing some measure of collimation along with light redirection. FIGS. 8A and 8B provide a comparison of light redirection with and without convex surface curvature. FIG. 8A shows light redirection for light-redirecting structures 24 having a substantially flat surface. FIG. 8B shows the improved light redirection for light-redirecting structures 24 having curved surface 44. The graphs of FIGS. 8A and 8B show relative luminance without and with curved surface 44, respectively.

Apex 32 at the junction of side surfaces 34 and 44 may be a point from this cross-sectional aspect, or may be a surface, shown as a flat facet 46 for some or all of light-redirecting structures 24 in FIG. 9. The use of a flattened apex 32 provides the benefits of improved manufacturing robustness and mechanical rigidity. The heights h of adjacent light-redirecting structures 24 may be the same or may be varied over a range of values. It is preferred that adjacent light-redirecting structures have substantially the same height and preferably all of the light-redirecting structures have substantially the same height.

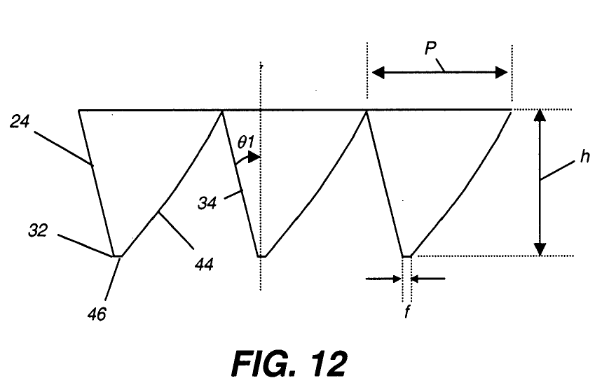

Referring to FIG. 12, various dimensions for light-redirecting structures 24 are shown. Pitch P, which can be measured from one apex 32 to the adjacent apex 32 or from the base of the groove for adjacent structures 24 as shown in FIG. 12, or from some other feature common to adjacent structures 24, is typically within the range of about 20 to 80 microns. Where flat facet 46 is used, its width ƒ is typically within the range of 1 to 10 microns. Angle of inclination θ1 for side surface 34 may range from 1 to 25 degrees.

Fabrication

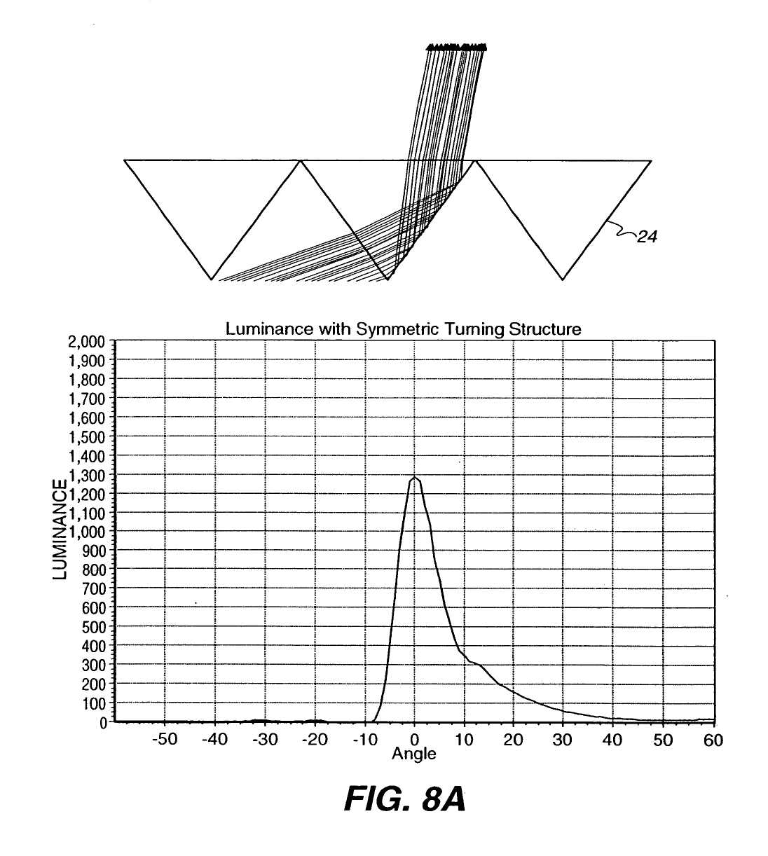

The light-redirecting article may be fabricated as a layer integral with a film substrate, that is, formed into the surface of a substrate, or the light-redirecting structures may be formed on a separate material and applied to a substrate layer. In one embodiment, light-redirecting article 40 is fabricated as a turning film in an injection roll molding process. Generally the light-redirecting article is manufactured by a method comprising a) rotating a cylinder; b) scribing the rotating cylinder with a tool to form adjacent scribe marks having a pitch that, over one full rotation of the cylinder, varies by more than +/−3%; and c) forming the light-redirecting article using the scribed cylinder in an injection roll molding process. Referring to FIG. 7, there is shown a cylinder 50 that is impressed with a tooling pattern 52 shown in greatly exaggerated and expanded form. Cylinder 50 prepared in this manner can then be used for fabrication of a turning film. In injection roll molding, described for example in commonly assigned U.S. patent application Ser. No. 2004/0090426 entitled “Transparent flexible sheet for resistive touch screen” by Bourdelais et al., a molten polymer is injected under pressure into a nip formed by a patterned roller and a backing roller to form a patterned film. Cylinder 50, prepared by scribing as shown in FIG. 8, could thus serve as the patterned roller in such a fabrication process. Cylinder 50 could be, for example, a copper- or nickel-plated structure.

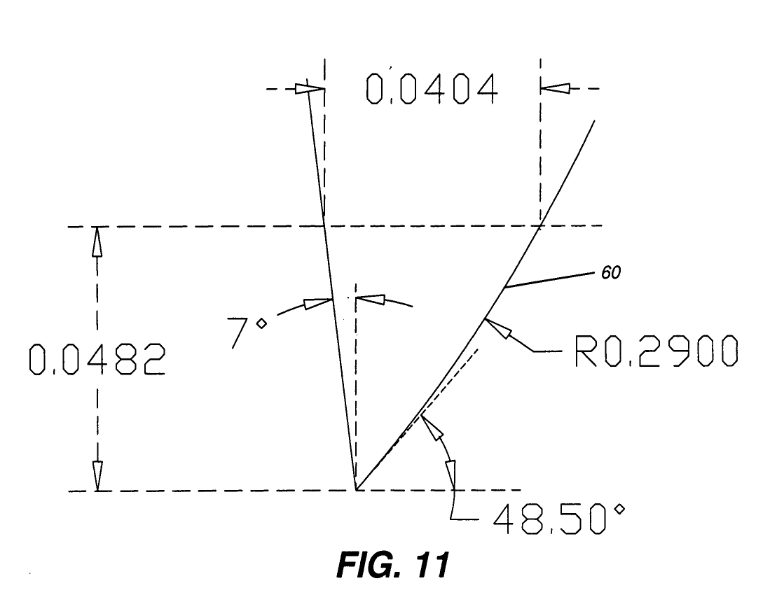

Referring to FIG. 11, there is shown a scribing tool 60 that can be used for forming tooling pattern 52 onto cylinder 50 in one embodiment. Dimensions shown are in inches.

Other methods for fabrication of light-redirecting article 40 of the present invention include various molding methods, including extrusion film casting, for example. In extrusion film casting, a polymer or polymer blend is melt extruded through a slit die, T-die, coat-hanger die, or other suitable mechanism. The extruded web having the preferred geometry is then rapidly quenched to below its glass solidification temperature upon a chilled casting drum so that the polymer retains the shape of the roller geometry. Alternately, light-redirecting article 40 of the present invention may also be manufactured by vacuum forming around a pattern. Additionally, the light directing article may be formed by a molding and curing process including processes that employ heat or radiation, for example, UV cure.

In one embodiment, light-redirecting article 40 of the present invention is fabricated as a turning film of a flexible, transparent material, most preferably from a polymeric material. There are a number of suitable polymers for this purpose, including polyolefins, polyesters, polyamides, polycarbonates, cellulosic esters, polystyrene, polyvinyl resins, polysulfonamides, polyethers, polyimides, polyvinylidene fluoride, polyurethanes, polyphenylenesulfides, polytetrafluoroethylene, polyacetals, polysulfonates, polyester ionomers, acrylates, and polyolefin ionomers. Copolymers and/or mixtures of these polymers can be used.

Results of Randomization

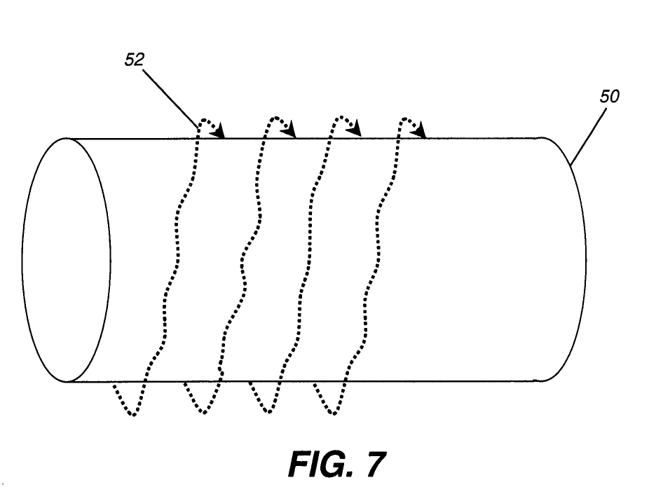

Randomization effects of light-redirecting structures 24 on light-redirecting surface 14 can be readily assessed using Fourier spectrum data. Referring to FIG. 6, there is shown a Fourier spectrum graph showing, for light-redirecting article 40 of the present invention, relative amplitude levels at various frequencies. A first curve 56 shows Fourier spectrum measurements from a turning film in which light-redirecting structures 24 are parallel, as shown in FIG. 5A. A second curve 58 shows Fourier spectrum measurements from a turning film in which light-redirecting structures 24 are not parallel, as shown in FIG. 5B. The reduced spectral values indicate lower potential moiré energy. Since Moiré is the convolution of two Fourier spectra (in this case, one spectrum from light gating device 20 in FIG. 1 and the other spectrum from light-redirecting article 40), reducing the amplitude of either spectrum helps to reduce Moiré perceptibility.

The randomization that is provided when using the present invention has, in some ways, an analogous effect to that achieved by rotation of a turning film relative to its light source. However, the randomization achieved by the present invention increases luminance with little or no potential for Moiré patterning.

Display Apparatus

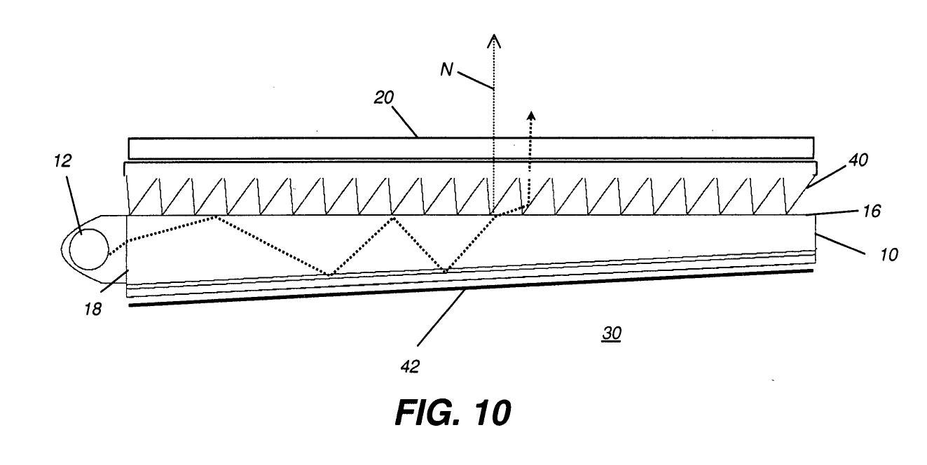

Referring to FIG. 10, there is shown display apparatus 30 using light-redirecting article 40 of the present invention. Light-modulating device 20 is preferably an LC device, such as a transmissive, thin-film transistor (TFT) display device. Where light source 12 is a CCFL (Cold-Cathode Fluorescent Light), the length of the CCFL is parallel to length L of light-redirecting article 40, as shown in FIG. 2.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

Thus, what is provided is a turning film having a randomized arrangement of light-redirecting structures for redirecting light from a light guiding plate.

### PARTS LIST

10. Light guiding plate
12. Light source
14. Light-redirecting surface
16. Output surface
18. Input surface
20. Light-modulating device
22. Turning film
24. Light-redirecting structures
28. Output face
30. Display apparatus
32. Apex
34. Surface
36. Surface
40. Light-redirecting article
42. Reflective surface
44. Curved surface
46. Flat facet
50. Cylinder
52. Tooling pattern
56. First curve
58. Second curve
60. Scribing tool
f. Width
h. Height
L. Length
P, P1, P2, P3, P4. Pitch
Q. Period
R. Ray
W. Width
θ₁, θ₂. Angle

1. A light-redirecting article having a width and a length, comprising:
a light-redirecting surface comprising a plurality of light-redirecting structures elongated along the length of the light-redirecting article and arranged side-by-side,
wherein each light-redirecting structure comprises:
(i) a first side surface oriented away from a normal to the light-redirecting article at a first angle;
(ii) a second side surface oriented away from a normal to the light-redirecting article at a second angle,
wherein the cross-sectional shape of each light-redirecting structure has at least one convex surface;
wherein the first and second side surfaces meet at an apex; and
wherein, for at least two adjacent light redirecting structures, over the length of the adjacent light redirecting structures the widthwise pitch between apexes of the adjacent light-redirecting structures varies by more than +/−3%.

2. The light-redirecting article of claim 1 wherein the apex is a flat surface.

3. The light-redirecting article of claim 1 wherein the light-redirecting article comprises a layer integral with a film substrate.

4. The light-redirecting article of claim 1 wherein the light-redirecting structures are applied to a substrate layer.

5. The light-redirecting article of claim 1 wherein at least two adjacent light-redirecting structures have substantially the same height.

6. The light-redirecting article of claim 1 wherein all of the light-redirecting structures have substantially the same height.

7. The light-redirecting article of claim 1 wherein the widthwise pitch between the apexes of the adjacent light-redirecting structures increases and decreases in a random pattern over the length of the light-directing surface.

8. The light redirecting article of claim 7 wherein the pitch between the apexes of the adjacent light-redirecting structures increases and decreases by more than +/−3% in a random pattern over the length of the element.

9. The light-redirecting article of claim 1 wherein at least two adjacent light-redirecting structures extend along a substantially sinusoidal path over the length of the light-directing surface.

10. The light-redirecting article of claim 1 wherein the first angle is between 1 and 25 degrees from normal.

11. The light-redirecting article of claim 1 wherein the convex curvature is spherical.

12. A method of manufacture of a light-redirecting article comprising:
a) rotating a cylinder;
b) scribing the rotating cylinder with a tool to form adjacent scribe marks having a pitch that, over one full rotation of the cylinder, varies by more than +/−3%; and
c) forming the light-redirecting article using the scribed cylinder in an injection roll molding process.

13. The method of manufacturing of claim 12 wherein the resulting light redirecting article has a width and a length, comprising:
a light-redirecting surface comprising a plurality of light-redirecting structures elongated along the length of the light-redirecting article and arranged side-by-side,
wherein each light-redirecting structure comprises:
(i) a first side surface oriented away from a normal to the light-redirecting article at a first angle;
(ii) a second side surface oriented away from a normal to the light-redirecting article at a second angle,
wherein the cross-sectional shape of each light-redirecting structure has at least one convex surface ; wherein the first and second side surfaces meet at an apex; and wherein, for at least two adjacent light redirecting structures, over the length of the adjacent light redirecting structures the widthwise pitch between apexes of the adjacent light-redirecting structures varies by more than +/−3%.

14. The method of manufacture according to claim 12 wherein scribing the rotating cylinder comprises tracing a substantially sinusoidal path with a scribing tool.

15. A display apparatus comprising
a) a light source;
b) a light guiding plate for directing light from the light source outward from an output surface, over a range of angles;
c) a light-redirecting article for accepting the light from the light guiding plate, the light redirecting article having a width and a length, comprising:
a light-redirecting surface comprising a plurality of light-redirecting structures elongated along the length of the light-redirecting article and arranged side-by-side,
wherein each light-redirecting structure comprises:
(i) a first side surface oriented away from a normal to the light-redirecting article at a first angle;
(ii) a second side surface oriented away from a normal to the light-redirecting article at a second angle,
wherein the cross-sectional shape of each light-redirecting structure has at least one convex surface;
wherein the first and second side surfaces meet at an apex; and
wherein, for at least two adjacent light redirecting structures, over the length of the adjacent light redirecting structures the widthwise pitch between apexes of the adjacent light-redirecting structures varies by more than +/−3%.
the light-redirecting article providing illumination thereby; and,
d) a light gating device for modulating the incident illumination from the light-redirecting article.

16. The display apparatus of claim 15 wherein the apexes of the light redirecting structures are a flat surface.

17. The display apparatus of claim 15 wherein the light-redirecting article is integral with a film substrate.

18. The display apparatus of claim 15 wherein the light-redirecting structures of the light redirecting article are applied to a substrate layer.

19. The display apparatus of claim 15 wherein the at least two adjacent light-redirecting structures of the light redirecting article have substantially the same height.

20. The display apparatus of claim 15 wherein all of the light-redirecting structures of the light redirecting article have substantially the same height.

21. The display apparatus of claim 15 wherein the widthwise pitch between the apexes of the adjacent light-redirecting structures increases and decreases in a random pattern over the length of the light-directing surface.

22. The display apparatus of claim 21 wherein the pitch between the apexes of the adjacent light-redirecting structures increases and decreases by more than +/−3% in a random pattern over the length of the light-directing surface.

23. The display apparatus of claim 15 wherein the apex angles of the at least two adjacent light-redirecting structures of the light redirecting article extend along a substantially sinusoidal path along the length of the light-directing surface.

24. The display apparatus of claim 15 wherein the first angle of the light redirecting structure is between 1 and 25 degrees from normal.

25. The display apparatus of claim 15 wherein the convex curvature of the cross-sectional shape of each light-redirecting structure is spherical.
